(19) United States
(12) Patent Application Publication
(10) Pub. No.: US 2015/0165889 A1
(43) Pub. Date: Jun. 18, 2015

(54) POWER TRANSMISSION UNIT FOR HYBRID VEHICLE

(71) Applicant: Toyota Jidosha Kabushiki Kaisha, Toyota-shi (JP)

(72) Inventors: Hirotatsu Kitabatake, Toyota-shi (JP); Yosuke Suzuki, Seto-shi (JP); Yuji Iwase, Okazaki-shi (JP); Yoshinobu Nozaki, Okazaki-shi (JP)

(21) Appl. No.: 14/573,346

(22) Filed: Dec. 17, 2014

(30) Foreign Application Priority Data
Dec. 17, 2013 (JP) 2013-260017

(51) Int. Cl. B60K 6/383; B60K 6/445; F16H 3/72

(52) U.S. Cl. CPC B60K 6/383; F16H 3/728; B60K 6/445; Y10S 903/913

(57) ABSTRACT

A power transmission unit for a hybrid vehicle in which a halting member for halting an output shaft of an engine does not elongate an axial length. The vehicle can be driven by another power unit while halting a rotation of the output shaft. One of end portions of the output shaft is connected with a transmission through a torque limiter, and a rotary member is attached to the other end portion of the output shaft to be rotated integrally. A halting member for halting a rotation of the output shaft is fitted onto the rotary member in a manner to overlap at least partially therewith in an axial direction.

The present invention claims the benefit of Japanese Patent Application No. 2013-260017 filed on Dec. 17, 2013 with the Japanese Patent Office, the disclosure of which is incorporated herein by reference in its entirety.

### BACKGROUND

1. Field of the Invention

The present invention relates to the art of a power transmission unit for hybrid vehicles allowed to be driven by a power generated by a power unit other than an internal combustion engine while halting an output shaft of the engine.

2. Discussion of the Related Art

For example, PCT International Publication WO2013/140527, JP-A-2009-120043 and JP-A-2012-510915 individually discloses a power transmission unit having a differential mechanism comprised of a first rotary element connected with an engine, a second rotary element connected with a motor-generator and a third rotary element connected with an output element to transmit a torque. In the power transmission unit of this kind, the first rotary element serves as a reaction element when transmitting an output torque of the motor-generator to an output member. For this purpose, the power transmission unit taught by the above-mentioned prior art documents is provided with a brake mechanism adapted to halt the first rotary element by connecting an output shaft of the engine with a stationary member such as a casing. Accordingly, provided that the motor-generator is operated to output a torque while stopping the rotation of the first rotary element by engaging the brake mechanism, the first rotary element is allowed to serve as the reaction element and the second rotary element is allowed to serve as an input element. Consequently, the torque outputted from the motor-generator is transmitted to the output member.

Specifically, according to the teachings of PCT International Publication WO2013/140527, a torque limiter for limiting the torque transmission is interposed between the engine and a power distribution device in order not to apply the torque excessively to a member of the power transmission unit, and the braking mechanism is interposed between the torque limiter and the engine.

In turn, JP-A-2003-90361 discloses a driving device for an auxiliary device. According to the teachings of JP-A-2003-90361, a transmission is connected with one of end portions of the output shaft of the engine, and the auxiliary device driven by a driving force of the engine is connected with another end portion of the output shaft through a one-way clutch adapted to transmit the power to the auxiliary device only when the engine is driven.

As disclosed, according to the teachings of PCT International Publication WO2013/140527, the brake mechanism is interposed between the engine and the torque limiter so that the torque will not be transmitted excessively to the brake mechanism. That is, it is possible to restrict both of the torques to be transmitted to the member of the power distribution device and to the brake mechanism by a single torque limiter. However, the brake mechanism thus arranged between the engine and the torque limiter may elongate the length of the output shaft of the engine as well as the power transmission unit.

The present invention has been conceived noting the foregoing technical problems, and it is therefore an object of the present invention is to provide a power transmission unit for a hybrid vehicle, in which a halting member for halting an output shaft of an internal combustion engine does not elongate the axial length of the power transmission unit.

### SUMMARY OF THE INVENTION

The power transmission unit of the present invention is applied to a hybrid vehicle which is comprised of an engine and another power unit, and which is allowed to be driven by a power of said another power unit while halting a rotation of an output shaft of the engine. In the hybrid vehicle of this kind, one of end portions of the output shaft of the engine is connected with a transmission mechanism for transmitting a power to driving wheels through a torque limiter. In order to achieve the above-explained object, according to the present invention, a rotary member is attached to the other end portion of the output shaft protruding from the engine in a manner to be rotated integrally therewith, and a halting member adapted to halt a rotation of the output shaft is fitted onto the rotary member in a manner to overlap at least partially therewith in an axial direction.

Specifically, the halting member is adapted to halt the rotation of the output shaft by connecting the rotary member with an engine body.

According to the present invention, for example, a power distribution device adapted to perform a differential action among rotary elements may be used as the transmission mechanism. To this end, the transmission mechanism is comprised of: a first rotary element connected with the engine to transmit a torque; a second rotary element connected with said another power unit to transmit a torque; and a third rotary element connected with the driving wheels to transmit a torque.

Thus, one of end portions of the output shaft of the engine is connected with the transmission mechanism, and the rotary member is attached to the other end portion of the output shaft protruding from the engine. In addition, the halting member adapted to halt a rotation of the output shaft is fitted onto the rotary member in a manner to overlap at least partially therewith in an axial direction. According to the present invention, therefore, the axial length of the power transmission unit will not be elongated by the halting member.

Specifically, the halting member is adapted to halt the rotation of the output shaft by connecting the rotary member with an engine body. This allows the torque limiter adapted to restrict the torque to be transmitted to the halting member. That is, it is unnecessary to arrange another torque limiter to restrict the torque to be transmitted to the halting member, in addition to the torque limiter for restricting the torque to be transmitted to the transmission mechanism. Therefore, the axial length of the power transmission unit will not be elongated by another torque limiter.

More specifically, the rotation of the output shaft is halted by connecting the rotary member with the engine body. For this reason, the rotary member is allowed to be situated close to the engine. Consequently, the axial length of the power transmission unit can be shortened.

### BRIEF DESCRIPTION OF THE DRAWINGS

Features, aspects, and advantages of exemplary embodiments of the present invention will become better understood with reference to the following description and accompanying drawings, which should not limit the invention in any way.

FIG. 1 is a skeleton diagram showing one example of the power transmission unit according to the present invention;

FIG. 2 is a nomographic diagram showing an operating state of rotary elements under the situation where the hybrid vehicle is driven in the forward direction by both motor-generators; and

FIG. 3 is a skeleton diagram showing another example of the power transmission unit according to the present invention.

### DETAILED DESCRIPTION OF THE PREFERRED EMBODIMENT(S)

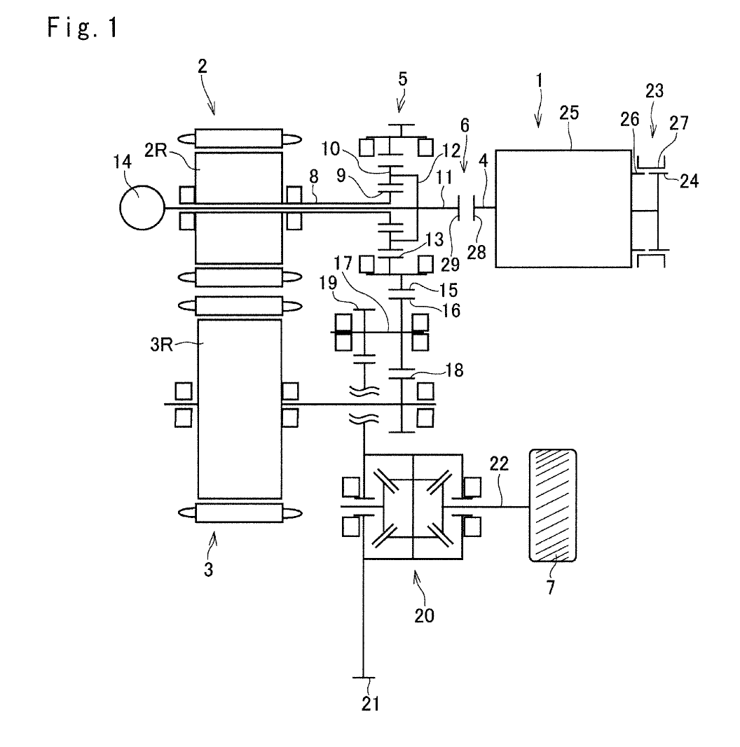

Referring now to FIG. 1, there is shown a preferred example of the power transmission unit for the hybrid vehicle according to the present invention. As can be seen from FIG. 1, the power transmission unit is comprised of an internal combustion engine (as will be simply called “the engine”) 1 and two motor-generators 2 and 3 serving as the power unit of the present invention. For instance, a conventional synchronous motor having a generating function is employed as each of the motor-generators 2 and 3. One of end portions of an output shaft 4 of the engine 1 is connected to a power distribution device 5 serving as the transmission mechanism of the present invention through an after-mentioned torque limiter 6. The power distribution device 5 is a differential mechanism adapted to distribute a torque from the engine 1 to the first motor-generator 2 and to driving wheels 7, and in the example shown in FIG. 1, a single-pinion planetary gear mechanism is employed as the power distribution device 5. Specifically, the power distribution device 5 is comprised of: a sun gear 9 connected with a output shaft 8 of the first motor-generator 2; a plurality of pinion gears 10 meshing with the sun gear 9; a carrier 12 holding the pinion gears 10 in a rotatable and revolvable manner that is connected with the engine 1 through an input shaft 11 of the power distribution device 5 to transmit the torque; and a ring gear 13 arranged concentrically with the sun gear 9 while meshing with the pinion gears 10. A rotor 2R of the first motor-generator 2 and the output shaft 8 penetrating therethrough are individually formed into cylindrical shape, and the input shaft 11 is inserted into the output shaft 8 to be connected with an oil pump 14. Accordingly, the career 12 serves as the first rotary element, the sun gear 9 serves as the second rotary element, and the ring gear 13 serves as the third rotary element of the present invention. Here, in FIG. 1, only one of the driving wheels is illustrated for the sake of convenience.

A drive gear 15 as an external gear is formed on an outer circumferential face of the ring gear 13. A counter shaft 17 is arranged in parallel with a rotational center axis of the power distribution device 5 and the output shaft 4, and a counter driven gear 16 is fitted onto the counter shaft 17 in a manner to be rotated therewith and to be meshed with the drive gear 15. Specifically, a diameter of the counter driven gear 16 is smaller than that of the drive gear 15 so that a decelerating action (i.e., amplification of the torque) can be achieved when transmitting the torque from the power distribution device 5 to the counter shaft 17.

According to this preferred example, the second motor-generator 3 is used to assist the torque transmitted from the power distribution device 5 to the driving wheels 7. To this end, the second motor-generator 3 is arranged in parallel to the counter shaft 17, and a reduction gear 18 connected with a rotor 3R thereof is meshed with the counter driven gear 16. Likewise, a diameter of the reduction gear 18 is further reduced to be smaller than that of the counter driven gear 16. Therefore, the torque of the second motor-generator 3 is allowed to be transmitted to the counter driven gear 16 or to the driving wheels 7 while being amplified.

The counter shaft 17 is further provided with a counter drive gear 19 in a manner to be rotated integrally therewith, and the counter drive gear 19 is meshed with a ring gear 21 of a differential gear 20 functioning as a final reduction gear unit. The differential gear 20 is connected with the driving wheels 7 through a drive shaft 22.

In the hybrid vehicle to which the power transmission unit of the present invention is applied, a driving mode can be selected from HV mode where the engine the engine 1 is used mainly as the prime mover, single motor mode where any one of the motor-generators (basically, the second motor-generator 3) is used as the prime mover, and twin motor mode where both motor-generators 2 and 3 are used as the prime mover. As described, the engine 1 is used mainly as the prime mover under the HV mode. To this end, the sun gear 9 of the power distribution device 5 is used as a reaction element thereby allowing the output torque of the engine 1 to be transmitted to the driving wheels 7. In this situation, the output torque of the first motor-generator 2 is controlled in accordance with the torque transmitted from the engine 1 to the power distribution device 5. Also, a speed of the first motor-generator 2 is controlled to achieve a target speed of the engine 1. That is, since the speed of the first motor-generator 2 can be varied continuously, the speed of the engine 1 can be varied continuously. Thus, the power distribution device 5 serves as a continuously variable transmission.

As mentioned above, the first motor-generator 2 is switched between the motor and the generator depending on the speed etc. Specifically, the first motor-generator 2 serves as a generator when outputting a torque in a direction to lower the rotational speed of the output shaft 8. In this case, the power generated by the engine 1 is partially converted into an electric power. By contrast, the first motor-generator 2 serves as a motor when outputting a torque in a direction to increase the rotational speed of the output shaft 8. In this case, the power generated by the first motor-generator 2 is added to the power of the engine 1. Thus, the power of the engine 1 to be transmitted to the driving wheels 7 is changed by controlling the first motor-generator 2 to use the sun gear 9 as the reaction element. As a result, if the power of the engine 1 is changed by the first motor-generator 2, a changed amount of the power is compensated by an output torque of the second motor-generator 3. For example, when the first motor-generator 2 serves as a generator, the second motor-generator 3 will output the torque to cover the reduction of the power of the engine 1. In contrast, when the first motor-generator 2 serves as a motor, the second motor-generator 3 will generate an electric power using the surplus power added by the first motor-generator 2. Thus, under the HV mode both of the first motor-generator 2 and the second motor-generator 3, and the engine 1 serve as the prime mover.

In case a demanded driving force is comparatively small, the vehicle can be driven only by the power of the second motor-generator 3. In this case, therefore, the single motor mode can be selected. Under the single motor mode, specifically, fuel supply to the engine 1 is interrupted, and the first motor- generator 2 is in unenergized condition. Since a mass and an internal friction of the engine 1 are larger than those of the first motor-generator 2, the first motor-generator 2 is idled but the engine 1 will not be rotated provided that the vehicle is driven under the single motor mode.

To the contrary, in case a demanded driving force is comparatively large, the vehicle cannot be driven only by the power of the second motor-generator 3. In this case, however, it is possible to select the twin motor mode to transmit the power of the first motor-generator 2 to the driving wheels 7 in addition to the power of the second motor-generator 3. In order to transmit the power of the first motor-generator 2 to the driving wheels 7, it is necessary to use the sun gear 9 as the input element and the career 12 as the reaction element by stopping a rotation of the output shaft 4. For that sake, according to the preferred example shown in FIG. 1, a dog clutch 23 adapted to selectively halt a rotation of the output shaft 4 is disposed on an opposite side of the engine 1 to the power distribution device 5. Accordingly, the dog clutch 23 serves as the halting member of the invention.

Hereinafter, a structure of the dog clutch 23 will be explained in more detail. As described, the dog clutch 23 for halting a rotation of the output shaft 4 is disposed on the opposite side of the power distribution device 5 across the engine 1. Specifically, an inertial mass 24 serving as a damper mass for suppressing torque pulses of the engine 1 is attached to a leading end of the output shaft 4 protruding from the engine 1 toward the opposite side of the power distribution device 5 in a manner to rotate integrally therewith. Accordingly, the inertial mass 24 corresponds to the rotary member of the invention.

A plurality of splines are formed on an outer circumferential face of the inertial mass 24. Meanwhile, a cylindrical protrusion 26 protrudes from an engine body 25 toward the inertial mass 24 in the axial direction. Here, an outer diameter of the cylindrical protrusion 26 is substantially identical to that of the inertial mass 24. Also, a plurality of splines are formed on an outer circumferential face of the cylindrical protrusion 26. Further, a sleeve 27 adapted to be meshed with those splines is fitted onto the inertial mass 24 to selectively connect the inertial mass 24 with the cylindrical protrusion 26. For the purpose of reciprocating the sleeve 27 in an axial direction, the power transmission unit is provided with a not shown hydraulic actuator or an electromagnetic actuator. Therefore, the rotation of the output shaft 4 can be halted by moving the sleeve 27 to a position to be engaged with both of the inertial mass 24 and the cylindrical protrusion 26 thereby halting the rotation of the inertial mass 24 integrated with the output shaft 4. By contrast, the output shaft 4 is allowed to be rotated by moving the sleeve 27 to a position to be engaged with only one of the inertial mass 24 and the cylindrical protrusion 26 thereby allowing the rotation of the inertial mass 24.

Thus, according to the preferred example shown in FIG. 1, the inertial mass 24 serving as a damper mass is attached to the leading end of the output shaft 4 protruding from the engine 1 toward the opposite side of the power distribution device 5. Additionally, a pulley for driving an auxiliary device such as an alternator may be arranged integrally with the output shaft 4 of the inertial mass 24 side. Alternatively, it is also possible to arrange a rotary member of an auxiliary device such as a water pump integrally with the output shaft 4 of the inertial mass 24 side. In such cases, the rotation of the output shaft 4 is halted by connecting a rotary member of the auxiliary device with a stationary member such as the engine body 25. Alternatively, it is also possible to halt the rotation of the output shaft 4 by connecting the inertial mass 24 with a not shown stationary member such as a casing.

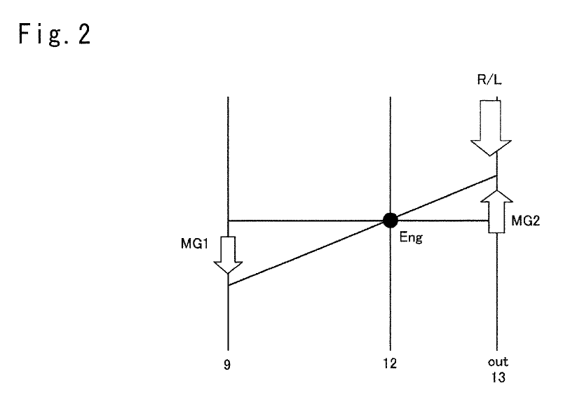

As described, the career 12 of the power distribution device 5 is allowed to serve as the reaction element by thus engaging the inertial mass 24 with the engine body 25 to halt the rotation of the output shaft 4. Referring now to FIG. 2, there is shown a nomographic diagram indicating an operating state of the rotary elements of the power distribution device 5 under the situation where the motor-generators 2 and 3 individually output a driving force while halting the rotation of the output shaft 4. As indicated in FIG. 2, if the power is outputted from the first motor-generator 2 under the condition that the rotation of the output shaft 4 is halted, a torque appears on the ring gear 13 in the opposite direction. In this situation, the torque outputted from the second motor-generator 3 is added to the torque of the first motor-generator 2 thereby establishing a driving force to be outputted. In the situation shown in FIG. 2, the torque resulting from running resistance (R/L) counteracts against the torque from the second motor-generator 3.

In addition, under the twin motor mode, the vehicle can be propelled in the reverse direction by the driving forces of the motor-generators 2 and 3. Further, when breaking the vehicle under the twin motor mode, a breaking force can be established by using the motor-generators 2 and 3 as generators, and in this situation, the inertial force of the running vehicle can be converted into an electric energy.

Thus, according to the preferred example shown in FIG. 1, the dog clutch 23 for halting a rotation of the output shaft 4 is fitted onto the inertial mass 24 as the rotary member attached to the end portion of the output shaft 4 protruding toward the opposite side of the power distribution device 5 from the engine body 25. That is, the sleeve 27 of the dog clutch 23 is situated radially outside of the inertial mass 24 while being overlapped at least partially therewith in an axial direction. Therefore, the axial length of the power transmission unit can be shortened in comparison with the case in which the halting member in disposed between the engine and the torque limiter. In addition, the cylindrical protrusion 26 to be engaged with the inertial mass 24 via the sleeve 27 to halt the rotation of the output shaft 4 is formed integrally with the engine body 25. Therefore, the inertial mass 24 is allowed to be situated closer to the engine body 25 in comparison with the case in which an additional stationary member is disposed to be engaged with the inertial mass 24. That is, a distance between the inertial mass 24 and the engine body 25 is reduced so that the length of the output shaft 4 is shortened. For this reason, the entire axial length of the power transmission unit is shortened.

If the torque is inputted to the vehicle from the driving wheels 7 according to the running resistance under the twin motor mode, such torque inputted from the driving wheels 7 will also applied to the gears of the power distribution device 5 and the dog clutch 23. In order to prevent deterioration in durability of those gears and the dog clutch 23, according to the preferred example shown in FIG. 1, the above-mentioned torque limiter 6 is disposed on an end portion of the output shaft 4 protruding toward the power distribution device 5. For this purpose, a torque transmitting capacity of the torque limiter 6 is determined based on stiffness of the gears and the dog clutch 23.

For example, a conventional torque limiter adapted to restrict the torque transmitted therethrough can be used as the torque limiter 6. Specifically, the torque limiter 6 is comprised of a first engagement member 28 connected with the output shaft 4, a second engagement member 29 connected with the input shaft 11 of the power distribution device 5 to be opposed to the first engagement member 28, and a not shown spring for pushing any one of the engagement members 28 and 29 onto the other one. That is, the torque limiter 6 is adapted to cause a slip between the engagement members 28 and 29 if a torque applied thereto exceeds a torque transmitting capacity thereof governed by each friction coefficient of the engagement member 28 and 29 and an elastic force of the spring.

Therefore, if such excessive torque is applied to the torque limiter 6, a slippage is caused between the engagement member 28 and 29 so that the reaction force acting on the power distribution device 5 is damped and torques acting on the gears interposing between the torque limiter 6 and the driving wheels 7 are reduced. In this situation, the torque transmitted to the dog clutch 23 is also reduced. For this reason, the torque will not act excessively on the gears of the power distribution device 5 and the dog clutch 23. Here, the structure of the torque limiter 6 should not be limited to the forgoing example. In addition, provided that the conventional torque limiter 6 is thus arranged between the engine 1 and the driving wheels 7, the dog clutch 23 can be prevented from being subjected to a load excessively by controlling an engagement pressure of the dog clutch 23.

As explained, the torque limiter 6 is disposed on the end portion of the output shaft 4 protruding toward the power distribution device 5, and the dog clutch 23 is disposed on the other end side of the output shaft 4 to halt the rotation of the output shaft 4. Therefore, the torque limiter 6 restricts the torque transmitted to the dog clutch 23 even if the torque is inputted from the driving wheels 7 excessively. This means that there is no need to arrange an additional torque limiter 6 for restricting the torque to be transmitted to the dog clutch 23 so that the axial length of the power transmission unit will not be elongated.

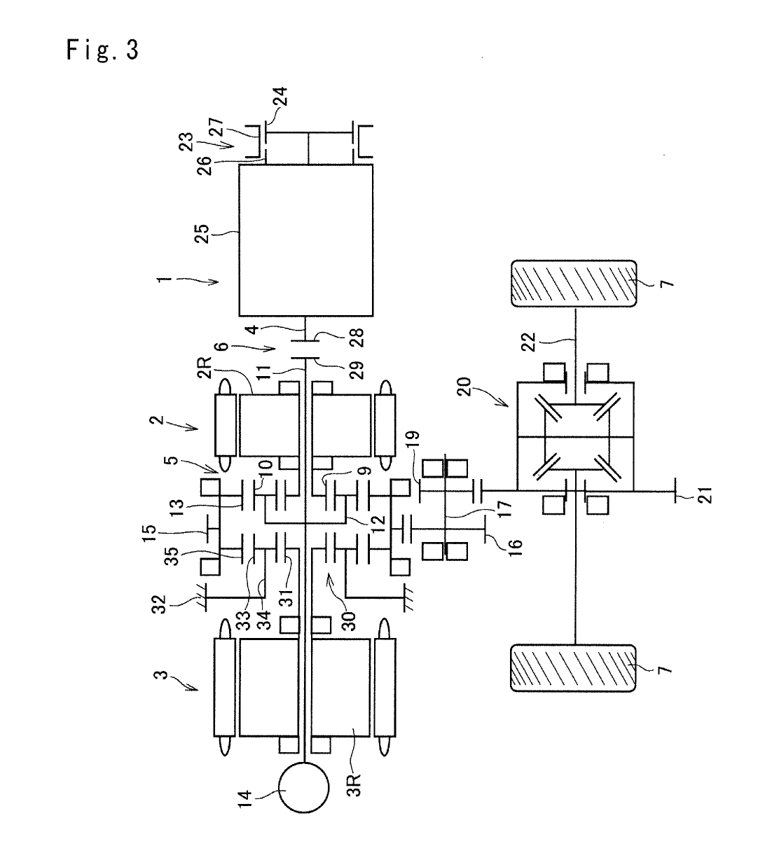

The present invention may be applied not only to the hybrid vehicle shown in FIG. 1 but also to the hybrid vehicle shown in FIG. 3. As shown in FIG. 3, the second motor-generator 3 is arranged coaxially with the engine 1 and the first motor-generator 2. In order to amplify the torque transmitted from the second motor-generator 3 to the driving wheels 7, the second motor-generator 3 is connected with a speed reduction mechanism 30. For this purpose, the single-pinion planetary gear mechanism is employed as the speed reduction mechanism 30. Specifically, the speed reduction mechanism 30 is comprised of: a sun gear 31 connected with the second motor-generator 3; a plurality of pinion gears 33 meshing with the sun gear 31; a carrier 34 holding the pinion gears 33 in a rotatable and revolvable manner that is connected with the stationary member such as a casing 32; and a ring gear 35 connected with the ring gear 13 in a manner to be rotated integrally therewith while meshing with the pinion gears 33. The remaining structures of the example shown in FIG. 3 are similar to those of the example shown in FIG. 1. Accordingly, the driving mode may also be selected from the HV mode, the single motor mode and the twin motor mode.

Thus, according to the foregoing examples, the rotation of the output shaft 4 is halted by the dog clutch 23 adapted to engage the inertial mass 24 and the engine body 25. That is, provided that the vehicle is driven in the forward direction under the twin motor mode, the torque will act on the output shaft 4 in a direction to rotate in an opposite direction to the output torque of the engine 1. Therefore, the one-way clutch adapted to be engaged to halt the rotation of the output shaft 4 only when the torque acts on the output shaft 4 in such a manner may be employed instead of the dog clutch 23. In this case, an engagement member of the one-way clutch is disposed on the inertial mass 24, and the engagement member is engaged with another engagement member integrated with the engine body 25 only when the torque acts on the output shaft 4 in the opposite direction to the output torque of the engine 1.

What is claimed is:

1. A power transmission unit for a hybrid vehicle which is comprised of an engine and another power unit, and which is allowed to be driven by a power of said another power unit while halting a rotation of an output shaft of the engine,
wherein one of end portions of the output shaft of the engine is connected with a transmission mechanism for transmitting a power to driving wheels through a torque limiter;
wherein a rotary member is attached to the other end portion of the output shaft protruding from the engine in a manner to be rotated integrally therewith; and
wherein a halting member adapted to halt a rotation of the output shaft is fitted onto the rotary member in a manner to overlap at least partially therewith in an axial direction.

2. The power transmission unit for a hybrid vehicle as claimed in claim 1,
wherein the halting member is adapted to halt the rotation of the output shaft by connecting the rotary member with an engine body.

3. The power transmission unit for a hybrid vehicle as claimed in claim 1,
wherein the transmission mechanism includes a power distribution device adapted to perform a differential action among a first rotary element connected with the engine to transmit a torque, a second rotary element connected with said another power unit to transmit a torque, and a third rotary element connected with the driving wheels to transmit a torque.
